(19) United States
(12) Patent Application Publication
(10) Pub. No.: US 2017/0223541 A1
(43) Pub. Date: Aug. 3, 2017

(54) METHOD AND APPARATUS FOR CONTROLLING ACCESS TO A TELECOMMUNICATIONS NETWORK

(71) Applicant: VODAFONE IP LICENSING LIMITED, London (GB)

(72) Inventor: Youssef CHAMI, London (GB)

(21) Appl. No.: 15/314,480

(22) PCT Filed: May 27, 2015
(86) PCT No.: PCT/EP2015/061748

§ 371 Date: Nov. 28, 2016

(30) Foreign Application Priority Data
May 28, 2014 (GB) 1409491.6

(51) Int. Cl. H04W 12/08; H04W 48/06

(52) U.S. Cl. CPC H04W 12/08; H04W 48/06

(57) ABSTRACT

A method of controlling access to a telecommunications network is disclosed. One of a plurality of commercial UEs receives an SIB2 signal from the network. The SIB2 includes a threshold signal BF (0<BF<1) representative of network load at a given time, and a time signal BT. In response to the received SIB2, the commercial UE generates a random number RD1, between 0 and 1. The random number RD is compared with the threshold value BF and, where the value RD1 for the commercial UE is below the threshold BF, the commercial UE is denied access to the network. If the random number exceeds the threshold value BF, the commercial UE is permitted access to the network. Emergency Services UEs have priority access. The value BF is dynamically changed such that, at times of relatively higher network load, there is a relatively lower probability of the commercial UEs in the network being permitted access to the network, than the probability of access for those commercial UEs when there is a relatively lower network load. ES UEs receive priority access at all times.

### FIELD OF THE INVENTION

This invention relates to a method of controlling access to a telecommunications network such as a Long Term Evolution (LTE) cellular network. The invention also extends to a network controller, and to a telecommunications network.

### BACKGROUND OF THE INVENTION

The Third Generation Partnership Project (3GPP) has been developing enhancements to cellular systems to allow their operation for public safety or emergency services (ES) communications. These are especially intended to work with the Long Term Evolution (LTE) architecture. Aims of this approach may include: reduced cost; improved functionality; and increased flexibility in comparison with existing public safety communication infrastructure, such as the Terrestrial Trunked Radio (TETRA) network.

The objectives specified for critical voice and broadband services are that it should be affordable, to address pressures on user budgets; that it should be enhanced relative to the TETRA network, in order to provide integrated broadband services to meet user needs; and that it should be flexible, so as better to match and be responsive to user demand.

One of the challenges of supplying ES communications over a commercial LTE network is to ensure that commercial users do not routinely experience degraded performance (for example, dropped calls, denial of service and so forth), whilst at the same time recognising the primacy and importance of ensuring robust and secure communications by, to and between the emergency services.

In particular, according to network statistics, utilisation of the network during the “Busy Hour” (BH) is considerably higher than at other times of the day, which means that radio resources need to be dimensioned in such a way that the commercial and ES have enough resources are available to handle the BH traffic for both types of traffic with minimal impact of the commercial customers using Quality of Service (QoS) as a means to differentiate users and/or traffic type i.e ES traffic/ users have higher priority than commercial traffic.

A User Equipment (UE)—that is, typically, a handset such as a mobile telephone—classified as commercial is allocated randomly to one out of ten network access classes. The random allocation is performed by the SIM manufacturer or the service provider and is provisioned at the SIM/USIM prior to customer use. The allocation may be reconfigured for over-the-air (OTA)) mobile populations, defined as Access Classes (AC) 0 to 9. The population number is stored in the SIM/USIM.

In addition, UEs may be members of one or more out of 5 special (high priority) categories (Access Classes 11 to 15), also held in the SIM/USIM. These are allocated to specific high priority users. The allocation is performed on-demand by customer services and the value provisioned OTA.

Class 15—PLMN Staff;

Class 14—Emergency Services;

Class 13—Public Utilities (e.g. water/gas suppliers);

Class 12—Security Services;

Class 11—For PLMN Use.

The skilled reader will recognise that none of the access class numbers are indicative of a hierarchy of importance, save that access classes 0-9 are reserved for commercial users whereas access classes 10-15 are reserved for higher priority users including the ES.

Although the network is dimensioned to allow both commercial and ES users to access it simultaneously in most normal situations, there are nevertheless cases where it is necessary to prioritise ES access to the network at the expense of commercial users. In that situation, mobile originated (MO) and Mobile Terminated (MT) calls may be denied access to the network. This denial of access in accordance with the type of user is known as Access Class Barring. For example, during emergency situations or during periods of high congestion (for example during the Busy Hour), it may be necessary to restrict access by commercial users so that the ES can continue successfully and robustly to communicate.

Restricting access to the network by commercial users is undesirable. The present invention accordingly seeks to provide a method of controlling network access which recognises the criticality of ES access but which nevertheless seeks to minimise any reduction in the quality of service to commercial users.

### SUMMARY OF THE INVENTION

According to a first aspect of the present invention, there is provided a method of controlling access to a telecommunications network, as set out in claim 1. A computer program in accordance with claim 14 and a telecommunications network in accordance with claim 15 are also provided.

Preferred embodiments of the invention disclose a method dynamically to grant (or deny) access to a network for a UE of a first network user type, such as a commercial user, whilst prioritising access to that network (and preferably guaranteeing access to that network) for a UE of a second network user type such as the emergency services. In particular, the load on the network can be determined at various times and, where the UE(s) of the second network user type present an additional demand for services, access to the network for the UEs of the first network user type can be restricted if need be.

The idea is mainly carried out at the network side, but preferably requires some information from a service provider (this is because the network provider knows how many Emergency Services (ES) users are currently registered/active on the network—e.g., from the access class 11-15—but don't know if they need more resources due to the fact that the service to be provided requires more resources—e.g., in case of video streaming, etc.)

So, the service provider tells the network provider that it will need more resources for the ES users, and in response the service provider will dynamically change the Barring Factor (BF) and/or Barring Time (BT)—both standard parameters—for the commercial users in order to “bar” them in case the network cannot provide sufficient resources to the ES users. So, for example, if the ES users need more resources, and the load of the network will not allow them to be served, the network will decide a percentage of commercial users to “bar” from the network, and in accordance to that it will change the BF/BT to make sure that a certain random percentage of commercial users will be barred from using the network. Of course, all commercial users may be barred if necessary.

Preferably the UEs of the first network user type are randomly allocated an access class between 0 and 9. To gain access to a cell, a UE with the aforementioned access class generates a random number (RD₁). This may be a number between 0 and 1, for example. The random number RD₁ is generated in response to the receipt of a signal from the network, the received signal including a threshold value which is indicative of network load. That threshold value is, preferably, not constant but instead changes dynamically as the load on the network changes. More particularly, the threshold value may be determined based upon the network demand created by the UEs of the second network user type so as to ensure priority access to the network by the latter user type.

RD₁ is generated by the UE of the first network user type and, if the number generated falls to a first side of the threshold value BF, the UE of the first network user type is granted access. If the random number falls to the second side of the threshold value BF, that UE of the first network user type is denied access.

In this context, the telecommunications network may provide network connectivity, including lower layers of the networking protocol stack, for example one or more of: a physical layer; a link layer; a network layer; a transport layer; and a session later. The service provider may manage the higher layers of the protocol stack, which may comprise one or more of: a session layer; a presentation layer; and an application layer and typically comprises the user-plane traffic.

The random number RD is preferably generated in response to a system information block 2 (SIB2), received from the radio access network (RAN).

In that case, the SIB2 may include a threshold value BF in the form of a BarringFactor which is dependent on cell load at a time tₙ. The Barring Factor may be calculated by an algorithm. The SIB2 may also include a BarringTime (a pre-set time). Although in a preferred embodiment, the signal received from the network contains a BarringFactor and, optionally, the BarringTime as well, the signal received from the network might in alternative embodiments contain only the BarringTime.

It is preferable that the threshold value BFₙ for the time tₙ is normalised to the random number. In particular, both BFₙ and RD₁ may be unit intervals (ie take a value of 0, 1 or a real value in between 0 and 1).

If RD₁ falls to the second side of the threshold, so that the UE is denied access to the network, the process (termed a persistence test) of RD₁ generation and comparison with BFₙ is preferably suspended until the BarringTime has elapsed. Once that BarringTime has elapsed, the process of generation of RD₁ and comparison with BFₙ—or a different threshold BFₙ₊ᵢ—is repeated. The BarringTime may or may not be synchronised to the updating of the threshold value BFₙ: in one embodiment the updating of the threshold value is network driven, that is, changed when (and only when) the network is advised of a change in load, in particular as a result of a changed demand from/for the UEs of the second network user type. In that case, the time differences tₙ₊₁-tₙ will typically differ for n=1,2,3 . . . and successive threshold values will axiomatically differ since it is the change in network load that has prompted the recalculation of the threshold value.

In other alternatives, however, the threshold value BFₙ may be calculated at constant (or constant multiples of) time intervals, that is, at times t₁, t₂, t₃ . . . the network load is assessed. In that case, BF₁ may or may not be the same as BF₂, depending upon whether the network load has changed between the times t₁, t₂, t₃.

In one preferred embodiment, the threshold value BF increases with network load. Then, the UE is denied access when RD₁ is lower than BF, and permitted access when RD₁ exceeds BF. Since the Access Class for commercial users is allocated randomly, this means that, statistically, the probability of any one commercial user being permitted access to the network decreases as BF increases. In the extremes, where BF=0, all UEs of the first network user type (such as commercial users) will have an RD₁ which exceeds BF and so all UEs, regardless of the randomly allocated Access Class, will be permitted access to the network. At the other extreme, where BF=1, none of those UEs of the first network user type will be able to access the network. Between the two extremes, some but not all of the UEs of the first network user type will be able to access the network. With a random distribution of Access Classes and a large number of UEs of the first network user type seeking to access a particular cell, a BF of 0.5 will result in a random 50% of UEs of the first network user type being able to access that cell.

Of course it is possible to invert the comparison: BF=1 could instead represent a case of minimal network load whilst BF=0 could represent a case of maximum load. In other words, the threshold value BF might decrease with network load. Then, the UE is denied access when RD₁ is higher than BF, and permitted access when RD₁ is lower than BF.

The advantage of aspects of the invention is that, due to the dynamic nature of access class barring, commercial network users can also use the cell alongside emergency services (ES) users, up to a dynamically determined point, such that ES users are guaranteed—or at least have prioritized—access to the cell relative to commercial counterparts.

In a further aspect, there is provided a method of controlling access to a telecommunications network, the network including one or more UEs of a first network user type and one or more UEs of a second network user type, the method comprising: receiving a request for network resources for the one or more UEs of the second network user type; determining, based on said request, (i) an amount of network resources that are allowed to be used by the one or more UEs of the first network user type and/or (ii) a set of the one or more UEs of the first network user type are allowed to access the telecommunications network; and modifying a threshold value BF based on said determination. The set of the one or more UEs of the first network user type may be a percentage of the one or more UEs of the first network user type that are allowed to access the telecommunications network whilst allowing sufficient network resources to be allocated to the one or more UEs of the second network user type in response to said request. The threshold value BF may be modified so that only the determined amount of network resources are allowed to be used by the one or more UEs of the first network user type and/or the only the set of the one or more UEs of the first network user type are allowed to access the telecommunications network. Further, the method may comprise sending an indication of the modified threshold value BF to the one or more UEs of the first network user type. Further, a timing value BT may be also determined, and the indication may further include this determined value. The determined amount of network resources and/or the corresponding set of the one or more UEs of the first network user type may be such that, as a result of the controlling method, there are sufficient network resources to be allocated to the one or more UEs of the second network user type in response to said request. The method may further comprise: determining whether there are sufficient network resources to be allocated to the one or more UEs of the second network user type in response to said request. When it is determined that more network resources are needed to serve the one or more UEs of the second network user type, the amount of network resources that are allowed to be used by the one or more UEs of the first network user type and/or the set of the one or more UEs of the first network user type allowed to access the telecommunications network may be determined. The determined amount of network resources may corresponds to a difference between a total amount of network resources and a reserved amount of network resources to be allocated for use by the one or more UEs of the second network user type. The determined set of the one or more UEs of the first network user type may correspond to a proportion of the one or more UEs of the first network user type that are allowed to access the telecommunications network so that sufficient network resources are made available for allocation to the one or more UEs of the second network user type in response to said request.

In a further aspect, there is provided a network controller in a telecommunications network, said telecommunications network comprising a plurality of UEs of a first network user type, and a plurality of UEs of a second network user type, the network controller being configured to perform any one of the relevant methods described herein. Further, a telecommunications network comprising a plurality of UEs of a first network user type, a plurality of UEs of a second network user type and the network controller may also be provided.

All of the above methods, methodologies, functionalities and network elements may be combined in any suitable manner without departing from the present invention.

Further preferred features of the invention are set out in the accompanying claims and will further become apparent from a consideration of the following specific description of a particularly preferred embodiment. Additional advantages will also be discussed below.

### BRIEF DESCRIPTION OF THE DRAWINGS

The invention may be put into practice in a number of ways, and some preferred embodiments will now be described by way of example only and with reference to the accompanying drawings, in which:

FIG. 1 shows a highly schematic diagram of a network architecture for a cellular network including a network base station and a plurality of user equipment devices (UE) of first and second network user types;

FIG. 2 schematically depicts first and second UEs each of the first network user type, along with a network controller, to illustrate how network access is controlled in accordance with embodiments of the present invention;

FIG. 3 shows a schematic representation of the proportion of UEs of the first network access type in FIGS. 1 and 2 that are permitted and denied access to the network for a given network load;

FIG. 4 shows in graphical form how the method of embodiments of the present invention dynamically restricts access to the network of UEs of the first network user type whilst ensuring access and adequate resource provision by UEs of the second network user type; and

FIG. 5 shows a flow chart of decisions taken by the controller of FIG. 2, as network and UE parameters vary.

### DETAILED DESCRIPTION OF PREFERRED EMBODIMENTS

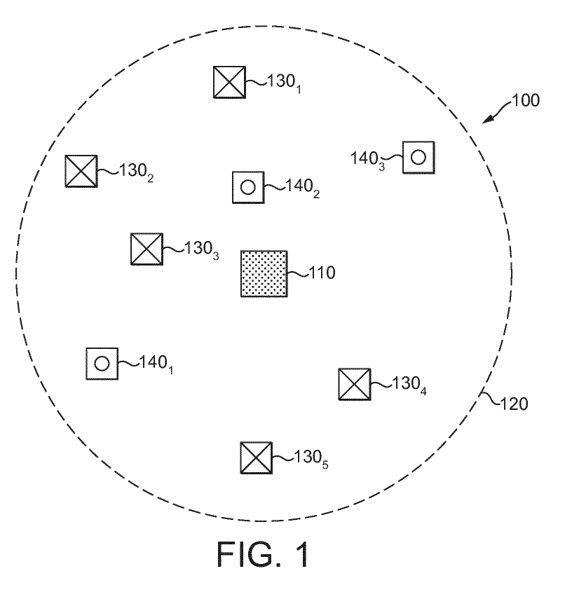

Referring first to FIG. 1, there is shown a highly schematic diagram of a part of a telecommunications network (E-UTRAN) 100. The network 100 comprises a plurality of commercial User Equipment nodes (UEs) labelled 130₁ to 130₅ each in communication with a base station 110. These commercial UEs each have an Access Class between 0 and 9, which is randomly allocated as explained above.

Also shown in FIG. 1 is a plurality of UEs of a second network user type, which in this illustrative embodiment represents UEs in the possession of the Emergency Services (ES). The ES UEs are labelled as 140₁ to 140₃ and again are each in communication with the base station 110.

It will of course be understood that a typical base station 110 will be communicating with many more UEs (of both the commercial and ES type) at any given time, and that there is no particular significance to be given to the relative numbers of each type of UE in FIG. 1 either. Hence FIG. 1 is intended merely to illustrate the principles of the present invention.

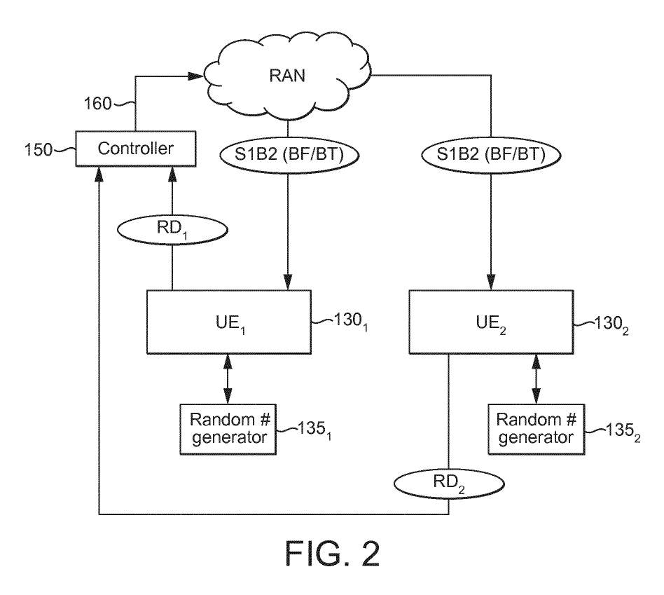

FIG. 2 shows two of the plurality of commercial UEs of FIG. 1 (those labelled 130₁ and 130₂ in FIG. 1), and illustrates schematically how their network access is controlled in accordance with embodiments of the present invention. Only two of the multiple commercial UEs 130 in FIG. 1 are shown in FIG. 2, for the sake of clarity.

In FIG. 2, each commercial UE 130 (identified by an access class between zero and nine) receives from a radio access network (RAN) a signal which contains SystemInformationBlockType2 (SIB2) information. The SIB2 includes, in turn, first and second network access parameters. The first is Barring Factor which is a threshold value representative of the current load on the network, that is, the total number of UEs (of either the commercial or ES type) along with the type of load being presented by the UEs: for example, a UE that is requesting or sending large quantities of data will present a higher network load than a UE that is simply handling an audio telephone call.

The second network access parameter included in the SIB2 is BarringTime whose purpose insofar as it applies to this preferred embodiment of the invention will be explained in further detail below.

The Barring Factor (BF) is a value between 0 and 1. BarringTime is a pre-set time. Both Barring Factor and BarringTime are determined at the RAN.

When a UE 130 receives the SIB2, it generates a random number RD. For the first commercial UE 130₁, the random number generated is denoted RD₁. For the second commercial UE 130₂, the random number generated is denoted RD₂. In general terms, RD₁ and RD₂ differ.

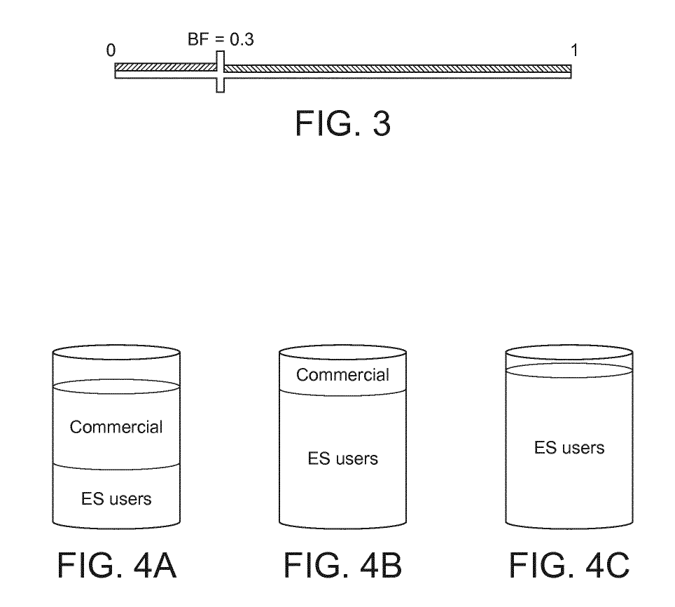

The random numbers RD₁, RD₂ are sent to a controller 150, which sits at the network side, but may additionally or alternatively be part of a UE. Here, each random number is compared with a first threshold value BFₙ representative of the current network load at a time tₙ (and where the higher is BFₙ, the higher is the network load). The controller 150 then sends an instruction 160 to the network so that, where RD₁>BFₙ, UE₁ 130₁ is permitted access to the network 100. If however RD₁<BFₙ, then the controller 150 instructs the network to deny UE₁ access to the network. Similarly, where RD₂>BF, controller 150 sends an instruction 160 to the network so that UE₂ 130₂ is permitted access to the network 100. If however RD₂<BF, then UE₂ 130₂ is denied access to the network. Because both RD₁ and RD₂ are random numbers, each commercial UE has an equal probability of being granted access to the network 100. That probability itself will however vary in accordance with the value of BF: where BF is 0, all of the commercial UEs 130 will be permitted access to the network 100 whereas when BF=1, none of the commercial UEs 130 will be permitted such access. Where BF=0.5, for example, a random 50% of those commercial UEs 130 connected to the base station 110 of the network 100 will be permitted access and the other 50% will be denied access. These principles are illustrated in simplistic terms in FIG. 3.

Once denied access, a commercial UE 130 is prevented from attempting access again until expiry of the BarringTime BT. At that time, the commercial UE 130 attempts again to access the network. If BF has not, during the BT, changed, then the commercial UE that has been barred from access will remain barred from access, in order to ensure that those (random) commercial UEs that have been granted access are not cut off from the network. Of course, if the BF reduces during the BT, then there is a higher probability of access by each of the commercial UEs when next the barred commercial UE tries to gain access to the network following the expiry of BT.

It is to be understood that the principles illustrated in FIG. 2 are applied only to the commercial UEs 130. In particular, ES UEs 140, identified by their Access Classes 11-15, are not subjected to access restrictions and can access the network regardless of load. In that regard, it is important that the network dimensions are configured so that, even during BH and at times of emergency, there is sufficient network capacity to permit the ES UEs 140 to access the network and receive those services required/requested. These principles are illustrated in FIG. 4. In FIG. 4A, a network load scenario is shown wherein there is sufficient capacity to permit all those commercial UEs 130 as well as all of the ES UEs 140 to access the network simultaneously, that is, BF=0. In FIG. 4B, however, 0<BF<1 so that some but not all of the commercial UEs are barred from the network, the specific commercial UEs 130 that are barred being determined randomly as explained above. Finally in FIG. 4C, BF=1 and none of the commercial UEs 130 are able to access the network, which is dedicated solely to the provision of services for ES UEs 140.

For users initiating emergency calls (Access Class 10) their access is controlled by BarringForEmergency (as defined by 3GPP TSTS22.011, the contents of which are incorporated herein by reference in their entirety). For ES UEs with Access Classes 11-15, their access is controlled by BarringForSpecialAC.

Thus, in summary of FIG. 2, the network (E-UTRAN) 100 is able to support access control based on the type of access attempt (i.e. mobile originating data or mobile originating signalling), in which indications to the UEs are generated by the controller 150 and then broadcasted across the network to guide the behaviour of the commercial UEs 130 in particular. The network E-UTRAN 100 is capable of forming combinations of access control based on the type of access attempt e.g. mobile originating and mobile terminating, mobile originating, or location registration. The ‘mean duration of access control’ and the barring rate are broadcasted for each type of access attempt (i.e. mobile originating data or mobile originating signalling).

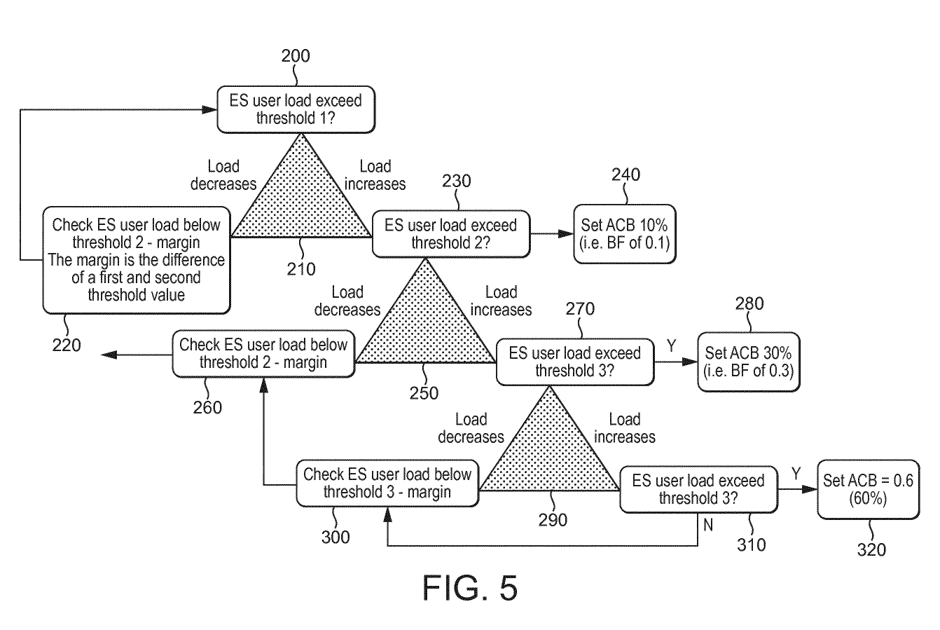

FIG. 5 shows a flow chart that illustrates how the BF is determined and broadcast to the commercial UEs, as the load across the network varies with time. The flow chart is read from top to bottom.

At box 200, it is determined whether or not the ES user load exceeds a first threshold E1. If the load then decreases (decision box 210), the network determines whether the ES user load falls below a second threshold E2—a margin (box 220). E2-margin is defined as the difference between a first and second threshold value.

If on the other hand the load increases at decision box 210, the network then determines whether the ES user load exceeds that second threshold value E2 (box 230). If yes, then at box 240, the network sets the BF to be 0.1 (in the example of FIG. 5), so that 10% of commercial UEs are denied access to the network, on a random basis, and the remaining 90% (which have a random number greater than BF=0.1) are permitted access to the network.

If the load then decreases again (decision box 250), the network determines whether the ES user load falls below the second threshold E2—a margin (box 260).

If on the other hand the load increases at decision box 250, the network then determines whether the ES user load exceeds a third threshold value E3 (box 270). If yes, then at box 280, the network sets the BF to be higher than previously, for example 0.3, so that this time 30% of commercial UEs are denied access to the network, on a random basis, with 70% now being permitted access.

The decision trees continues to assess whether the ES load is increasing or decreasing, as above. At decision box 290, again it is ascertained whether the load then decreases again; if it does, then the network determines whether the ES user load falls below the third threshold E3—a margin (box 300).

If on the other hand the load increases at decision box 290, the network then determines whether the ES user load exceeds a third threshold value E3 (box 270). If yes, then at box 320, the network sets the BF to be higher than previously, for example 0.6, so that this time 60% of commercial UEs are denied access to the network, on a random basis, with 40% now being permitted access.

Although the flow chart of FIG. 5 shows the principles of BF determination as the load on the network changes, it is of course to be understood that in reality the decision tree will contain more than 3 levels of decision making and that the BF will be allocated dynamically and repeatedly with time.

The controller 150 is responsible for allocating the service instance for each UE on the application layer, based on the popularity of the service and the location of the UE, wherein, the network itself 100 is responsible for allocating network resources or capacity, capability and available resources to host another instance of a service for commercial and Emergency service users.

In certain conditions, where the popularity of Push to Talk (PTT) calls or services, or where the available capacity or capability is limited for the commercial customers, the controller 150 and/or the network 100 will be able to activate the Automatic Access Barring algorithms to limit the number of commercial users permitted access to the cell, in order to improve network stability and ease the congestion.

1. A method of controlling access to a telecommunications network, the network including one or more UEs of a first network user type and one or more UEs of a second network user type, the method comprising:
(a) determining a network load representative of a demand for network resources;
(b) generating a threshold value BF based upon the determined network load;
(c) sending a signal including the threshold value BF to the UEs of the first network user type;
(d) controlling access to the network by the, or at least one of the, UEs of the first network user type based upon the threshold value BF whilst permitting access by the UEs of the second network user type; and
(e) generating a modified threshold value BF if the network load changes, so as to permit access to the network by a different number of UEs of the first network user type whilst maintaining access by the UEs of the second network user type.

2. The method of claim 1, wherein the step (d) of controlling access by the, or at least one of the, UEs of the first network type comprises: generating at a UE of the first network user type, a random number RD in response to the received signal including the value BF indicative of network load; comparing the threshold value BF received by the UE of the first network user type with the value RD for that UE; and (i) where the value RD for that UE falls to a first side of the threshold value BF, denying access to the network for that UE, and where the value RD for that UE falls to the other side of the threshold value BF, permitting access to the network for that UE.

3. The method of claim 2, further comprising receiving, at a further m (m>=1) UEs of the first network user type, the signal from the network which includes the value BF indicative of network load; generating, at the or each of the further m UE(s) of the first user type, a random number RDₘ in response to the received signal including the value BF indicative of network load; comparing the value BF with the value RDₘ for the each of the further m UEs of the first network user type; and, where the value RDₘ for an m^{th} one of the further UEs falls to the first side of the threshold value BF, denying access to the network for that m^{th} further UE, and where the value RDₘ for an m^{th} one of the further UEs falls to the other side of the threshold value BF, permitting access to the network for that m^{th} UE.

4. The method of claim 3, further comprising:
permitting access to the network by all of the UEs of both the first and second network user type when the network load is below a first level at a time tₙ;
permitting access to the network by the or each UE of the second network user type, but setting BF so as to deny access to the network by one or more but not all (m+1) of the UEs of the first user type, when the network load is above the first level but below a second, higher level; and
permitting access to the network by the or each UE of the second network user type, but setting BF so as to deny access to the network by all of the (m+1) of the UEs of the first user type, when the network load exceeds the second higher level but does not exceed a third lower level.

5. The method of claim 2, claim 3 or claim 4, wherein each of the threshold value BF, and the random number(s) RDₘ generated by the UE(s) of the first network user type, are normalized to have the same upper and lower range limits (BFₘᵢₙ, BFₘₐₓ; RDₘᵢₙ, RDₘₐₓ) as each other.

6. The method of claim 5, wherein the value of BFₘₐₓ is indicative of a maximum network load, the value of BFₘᵢₙ is indicative of a minimum network load, and the method further comprises preventing access to the network for the UE of the first network user type when RD₁<BFₙ (BFₘᵢₙ<BFₙ<BFₘₐₓ) and permitting access to the network for the UE of the first network type when RD₁>BFₙ (BFₘᵢₙ<BFₙ<BFₘₐₓ).

7. The method of claim 5 or claim 6, wherein RD₁ and BF each have a value between 0 and 1, BF=1 representing a highest network load, and BF=0 representing a lowest network load.

8. The method of any one of the preceding claims, wherein the second network user type is an Emergency Services (ES) user.

9. The method of any preceding claim, wherein the first network user type is a commercial user.

10. The method of any preceding claim, wherein the signal in the step (c) includes a system information block 2 (SIB2) from a radio access network (RAN), the SIB2 having a Barring Factor representing the value BF.

11. The method of any preceding claim, wherein the signal in the step (c) further includes a second threshold value BT representative of a time out period.

12. The method of claim 11, further comprising:
for any UEs of the first network user type which are prevented from accessing the network, waiting for a time period>=BT before determining again whether such UEs are permitted access to the network.

13. The method of any preceding claim, wherein the or each UE is connected to a first cellular base station of the cellular network, the threshold value BF being indicative of the load for that cellular base station.

14. A computer program configured to carry out the method of any preceding claim when operated by a processor.

15. A telecommunications network including a network controller, a plurality of UEs of a first network user type, and a plurality of UEs of a second network user type, the network controller being configured
(I) to receive an indication from the network of a load upon that network;
(II) to generate a threshold value BF representative of the load upon the network; and
(III) to output, to the network, a signal containing the threshold value BF;
the UEs of the first network user type being configured to receive the signal containing the threshold value BF and to have their access to the network controlled in accordance with that threshold value BF whilst the UEs of the second user type whilst maintaining access to the network by those UEs of the second user type.

16. The network of claim 15, wherein the UEs of the first user type have their access to the network restricted by generating a random number RD when they receive the signal including the threshold value BF, and comparing RD with the threshold value BF;
wherein, when the value RD for the UE falls to a first side of the threshold value BF, the UE of the first network user type is denied access to the network, and where the value RD for that UE of the first network user type falls to the other side of the threshold value BF, the UE of the first network user type is permitted access to the network.

17. The network of claim 15 or claim 16, wherein the controller is configured to update the threshold value BF when a service provider indicates to the network that a different resource level is or will be required.

18. The telecommunications network of claim 15-17, further comprising a network cell under the control of the controller.

19. The network of any of claims 15-18, wherein the first network user type is a commercial user, and the second network user type is a member of the emergency services.

20. The telecommunications network of any of claims 15-19, the network being of the Long Term Evolution (LTE) type.

21. A method of controlling access to a telecommunications network, the network including one or more UEs of a first network user type and one or more UEs of a second network user type, the method comprising:
receiving a request for network resources for the one or more UEs of the second network user type;
determining, based on said request, (i) an amount of network resources that are allowed to be used by the one or more UEs of the first network user type and/or (ii) a set of the one or more UEs of the first network user type are allowed to access the telecommunications network; and
modifying a threshold value BF based on said determination.

22. The method of claim 21, wherein the set of the one or more UEs of the first network user type is a percentage of the one or more UEs of the first network user type that are allowed to access the telecommunications network whilst allowing sufficient network resources to be allocated the one or more UEs of the second network user type in response to said request.

23. The method of claim 21 or 22, wherein the threshold value BF is modified so that only the determined amount of network resources are allowed to be used by the one or more UEs of the first network user type and/or the only the set of the one or more UEs of the first network user type are allowed to access the telecommunications network.

24. The method of any one of claims 21 to 23, further comprising:
sending an indication of the modified threshold value BF to the one or more UEs of the first network user type.

25. The method of any one of claims 21 to 24, wherein the determined amount of network resources and/or the corresponding set of the one or more UEs of the first network user type is such that, as a result of the controlling method, there are sufficient network resources to be allocated to the one or more UEs of the second network user type in response to said request.

26. The method of any one of claims 21 to 25, further comprising:
determining whether there are sufficient network resources to be allocated to the one or more UEs of the second network user type in response to said request.

27. The method of claim 26 wherein, when it is determined that more network resources are needed to serve the one or more UEs of the second network user type, the amount of network resources that are allowed to be used by the one or more UEs of the first network user type and/or the set of the one or more UEs of the first network user type allowed to access the telecommunications network is determined.

28. The method of any one of claims 21 to 27, wherein the determined amount of network resources corresponds to a difference between a total amount of network resources and a reserved amount of network resources to be allocated for use by the one or more UEs of the second network user type.

29. The method of any one of claims 21 to 28, wherein the determined set of the one or more UEs of the first network user type corresponds to a proportion of the one or more UEs of the first network user type that are allowed to access the telecommunications network so that sufficient network resources are made available for allocation to the one or more UEs of the second network user type in response to said request.

30. A network controller in a telecommunications network, said telecommunications network comprising a plurality of UEs of a first network user type, and a plurality of UEs of a second network user type, the network controller being configured to perform any one of the steps of claims 1 or 21 to 29.

31. A telecommunications network comprising a plurality of UEs of a first network user type, a plurality of UEs of a second network user type and a network controller in accordance with claim 30.
